(19) United States
(12) Patent Application Publication
(10) Pub. No.: US 2018/0042426 A1
(43) Pub. Date: Feb. 15, 2018

(54) COLLAPSIBLE SPLATTER GUARD

(71) Applicant: Robinson Home Products Inc., Williamsville, NY (US)

(72) Inventors: Louis J. Henry, Scarsdale, NY (US); Christopher M. Mellen, Yonkers, NY (US)

(21) Appl. No.: 15/236,825

(22) Filed: Aug. 15, 2016

(51) Int. Cl. A47J 37/10

(52) U.S. Cl. CPC A47J 37/101

(57) ABSTRACT

A collapsible splatter guard having a rigid base member having an inner perimeter and an outer perimeter and a collapsible guard member, the collapsible guard member being convertible from a fully collapsed configuration to a fully expanded configuration and having an opening. The collapsible guard member is preferably attached about the inner perimeter of the rigid base member, and comprises a flexible wall having one or more folds defining living hinges that fold to bring the collapsible wall into the fully collapsed configuration. A handle may be included on the rigid base member

### FIELD OF THE INVENTION

The present invention relates to kitchen accessories, and more particularly to a collapsible splatter guard which can be transformed from an expanded configuration to a collapsed configuration.

### BACKGROUND OF THE INVENTION

It is commonly known that frying or simmering foods on a stovetop can be a messy process, even for an experienced cook. Food, liquids, oil and/or grease (hereinafter “splattering materials”) often splatter outside the pot, pan or other cooking utensil and onto the adjacent areas of the stove and walls. Such splattering materials not only create unsightly messes on the stove tops, walls and surrounding surfaces, but also create an undue safety hazard to anyone nearby. The splattering of grease from inside a cooking utensil can not only cause severe burns on people, but also increases the likelihood of kitchen grease fires.

Additionally, since the walls of some cooking utensils, such as frying pans and skillets, are often low, it can be challenging to move the cooking utensil with the food contents to a different location without food slipping out from the cooking utensil.

In order to contain the splattering materials, to limit safety hazards and avoid messes in the kitchen, the conventional means is to place a lid over the cooking utensil. However, placing a lid over the opening of a cooking utensil throughout the entire cooking process is impractical for several reasons. For example, a lid prevents the cook from being able to observe the cooking process. Additionally, cooking often involves introduction, removal, stirring and/or turning of the food being prepared. Therefore, the lid would have to be removed continuously, which allows splattering materials to escape the cooking utensil. Further, the steam generated during the cooking process generally causes the lid to tremble on the cooking utensil as it escapes.

In light of these challenges, splatter guards for use in kitchens have been designed where the guard is affixed directly onto stove-top ranges. An example of such splatter guards can be found in U.S. Pat. No. 5,546,928 which is directed to a stove-mounted grease splatter guard comprising a flexible splatter protection portion which attaches to a stove via a base portion, and the protection portion extends outwardly from the stove at an obtuse angle.

Splatter guards have also been designed where the guard is placed directly on or over a cooking utensil. An example of such a splatter guard can be found in U.S. Pat. No. 6,056,146 which describes a splatter screen that can be stably placed on the top of a cooking utensil. This device includes a rim, a handle and a flat wire mesh screen retained within the rim. Another example of such a splatter guard can be found in U.S. Pat. No. 5,542,347 which is directed to a frying pan shield comprising a shield segment set having walls formed substantially about a pan perimeter portion.

These splatter guards have been developed to allow a user to fry and/or simmer foods without having to place a lid over the top of the cooking utensil. However, many of these guards either rest on the stovetop forming a shelter around the cookware but blocking the cook's access and view to other items on the stove, or completely obstruct the opening of the cookware requiring the cook to lift the shield in order to flip or stir the food item.

As such, notwithstanding the above, there is a need for an improved splatter guard, preferably one that may be placed directly on the top edge of a cooking utensil and provides both a view and direct access to the food being cooked in the cooking utensil while the splatter guard is in place.

### SUMMARY OF THE INVENTION

The collapsible splatter guard of the present invention is provided in order to overcome the shortcomings of the existing products by providing an improved splatter guard for placement directly on the top edge of a cooking utensil that prevents splattering materials from landing on adjacent areas of the stove or walls, while also providing convenient access to the food items through a central opening. It is further an object to provide such a splatter guard comprising a collapsible guard member that can be collapsed to minimize the size of the splatter guard for easy storage.

These and other objects are addressed by the present invention, directed to a collapsible splatter guard having a width adaptable to sit directly on the top edges of a variety of different sized cooking utensils. The collapsible splatter guard of the present invention offers an improvement over the prior art in that it comprises a central opening at the top of the splatter guard that is large enough to allow a user to view the food being cooked, to introduce or remove food from the cooking utensil, as well as stir and/or turn the food without removing the splatter guard. The present invention provides a further improvement over the prior art in that the wall of the splatter guard is positioned to catch any splattering materials and facilitate the sliding of the materials back into the cooking utensil.

More particularly, the present invention is directed to a collapsible splatter guard comprising a rigid base member having an inner perimeter and an outer perimeter and a collapsible guard member, the collapsible guard member being convertible from a fully collapsed configuration to a fully expanded configuration and having an opening. The collapsible guard member is preferably attached about an inner perimeter of the rigid base member, and comprises a flexible wall having one or more folds defining living hinges that fold to bring the collapsible wall into the fully collapsed configuration.

The flexible wall preferably comprises a substantially rigid rim about the terminal edge defining the opening, where the opening is preferably centrally located on the flexible wall. The substantially rigid rim about the terminal edge of the flexible wall helps maintain the shape of the guard member and aids in transforming the guard member between the expanded and collapsed configurations.

In the preferred embodiment, the rigid base member is a circular flange having a terminal outer diameter and an inner diameter to which the collapsible guard member is affixed. The outer diameter of the rigid base member is of a size adapted to rest on and fit various-sized cooking utensils having openings of up to about 14 inches or larger in diameter with the inner diameter that is of a size adapted to rest on and fit various sized cooking utensils having openings as small as about 8 inches or smaller.

It is further preferred that the substantially rigid rim of the collapsible splatter guard has a diameter that is less than the inner diameter of the rigid base member, and that the flexible wall extends upwardly from the flange on an angle such that the splattering materials are permitted to flow downwards along the flexible wall and back into the cooking utensil. The rigid base member is preferably composed of a durable, temperature resistant material, such as stainless steel, to securely maintain the splatter guard in place and to stand up to repeated use and washings.

The flexible wall of the collapsible guard member preferably extends continuously about the inner perimeter of base flange of the splatter guard, and has a vertical height sufficient to catch the splattering materials and prevent them from leaving the cooking utensil. Additionally, the flexible wall of the collapsible guard member preferably folds along one or more living hinges into a collapsed configuration wherein the folds of the collapsed body of the guard member are a height substantially even with the circular base flange.

The collapsible splatter guard also preferably comprises a handle that is permanently, removably or pivotally attached to the rigid base member. The preferred handle can be folded over the top of the collapsible splatter guard when the splatter guard is in its collapsed configuration for easy storage. In the preferred embodiment, the handle comprises a rigid material and most preferably a heat resistant material, such as a stainless steel wire with a silicone cover or coating. This feature helps to prevent the user from being burned during use.

### BRIEF DESCRIPTION OF THE DRAWINGS

The attached drawings are intended to better illustrate a preferred embodiment of the present invention without limiting the invention in any manner whatsoever.

FIG. 1 is a perspective view of the collapsible splatter guard of the present invention wherein the collapsible shield member is in its fully expanded configuration and the handle is in its open configuration.

FIG. 2 is a side view of the collapsible splatter guard of the present invention wherein the collapsible shield member is in its fully expanded configuration.

FIG. 3 is a top view of the collapsible splatter guard of the present invention.

FIG. 4 is a perspective view of the collapsible splatter guard of the present invention wherein the collapsible shield member is in its fully collapsed configuration and the handle is in its closed configuration.

FIG. 5 is a side view of the collapsible splatter guard of the present invention wherein the collapsible shield member is in its fully collapsed configuration and the handle is in its closed configuration.

FIG. 6 is an exploded view of the collapsible splatter guard of the present invention.

### DETAILED DESCRIPTION OF THE PREFERRED EMBODIMENT

The following description of the preferred embodiment is presented to describe the present invention and is not to be construed to limit the scope of the invention in any manner whatsoever.

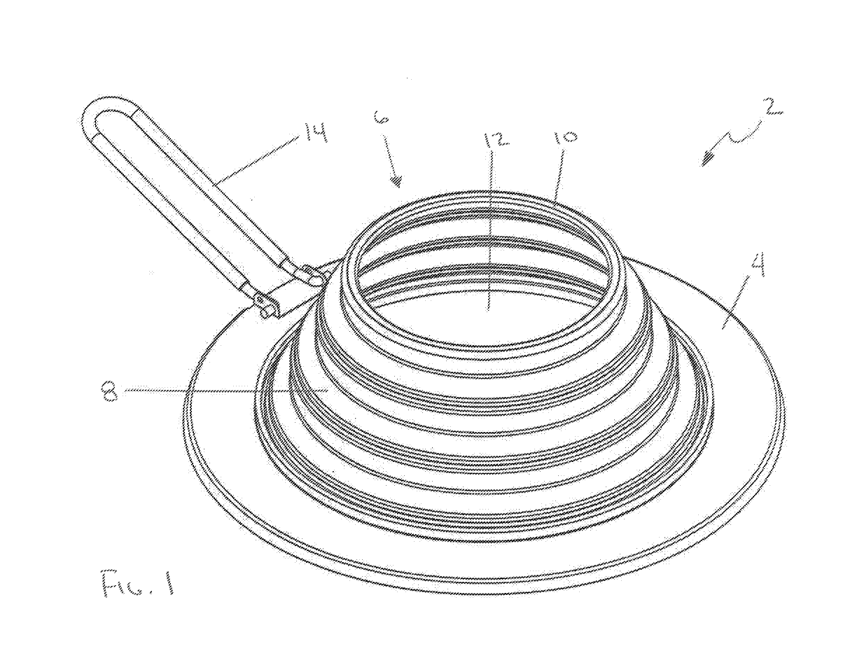

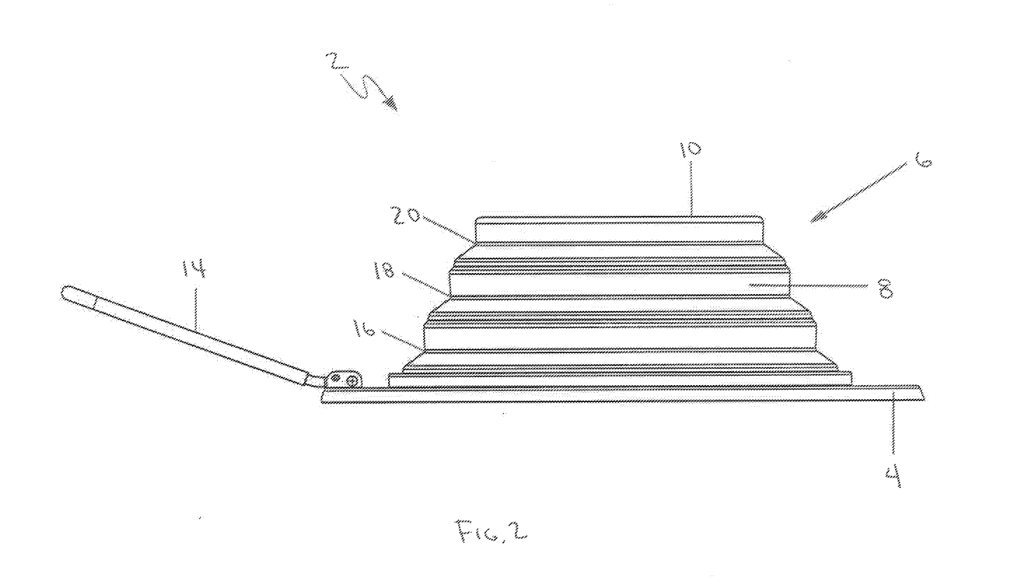

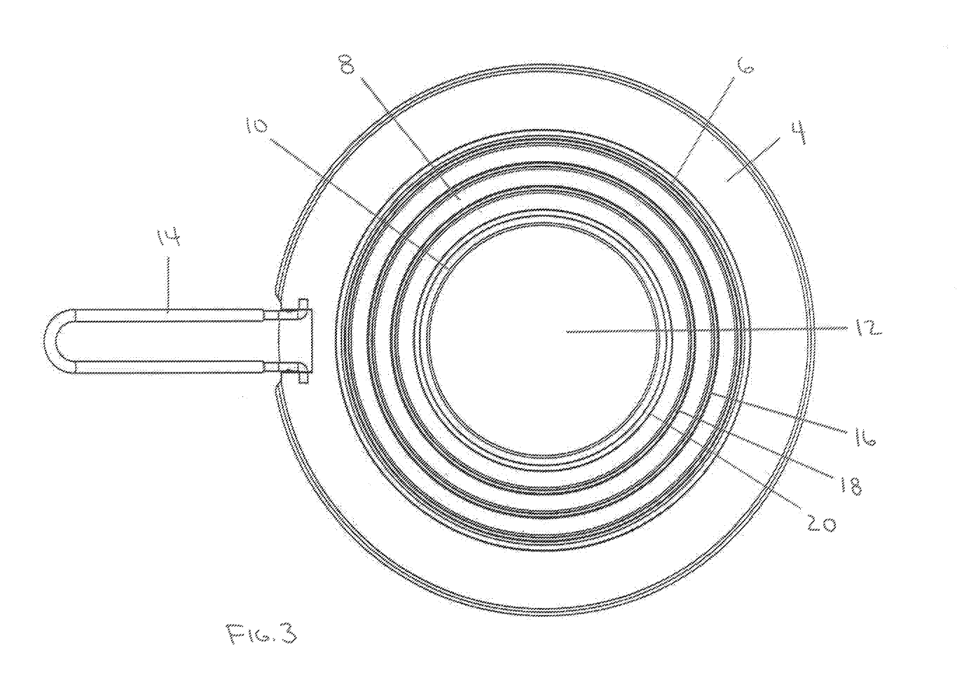

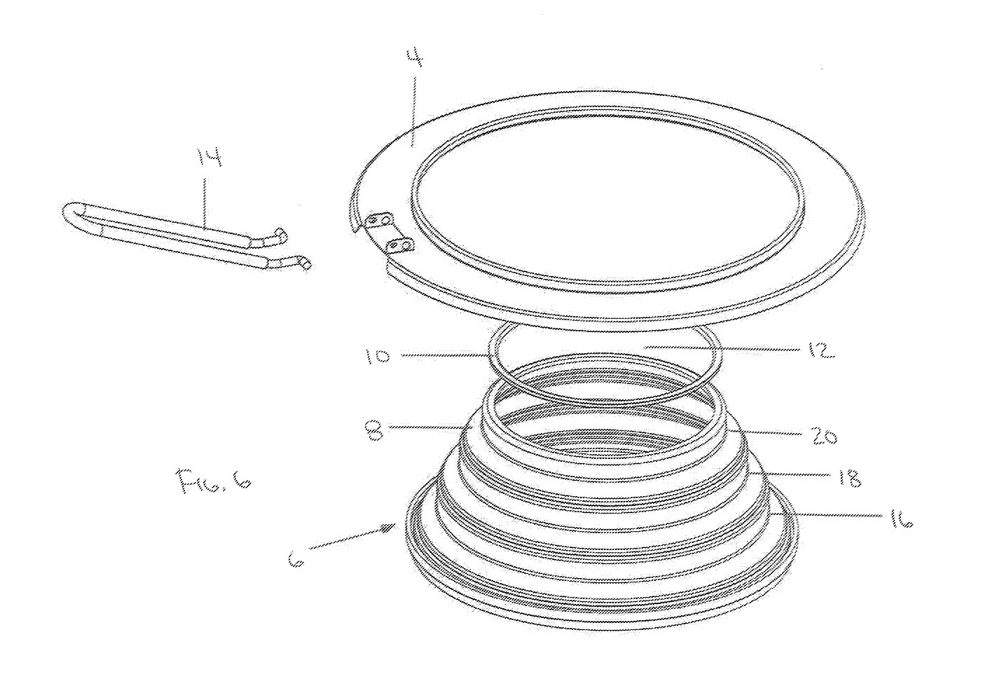

As best shown in the drawings, and particularly FIGS. 1-6, the preferred embodiment of the present invention is directed to a collapsible splatter guard 2 comprising a rigid base member 4 and a collapsible guard member 6 that is convertible from a fully collapsed configuration to a fully expanded configuration. The collapsible guard member 6 comprises a flexible wall 8, including one or more folds for collapsing the guard member 6, and a substantially rigid rim 10 defining a central opening 12 about the terminal edge of the flexible wall 8.

The collapsible guard member 6 preferably extends continuously about an inner diameter of the rigid base member 4, with the flexible wall 8 extending upwardly and inwardly to a maximum height sufficient to provide an enclosed area around the cooking utensil to collect splattering materials. The upward and inward angle of the flexible wall 8 allows collected splattering materials to flow back down the flexible wall 8 and into the cooking utensil.

In the preferred embodiment, the collapsible guard member 6 is molded along an inner diameter of the rigid base member 4 so that it collapses within the rigid base member 4 for easy storage. The rigid base member 4 is preferably a circular shape and has a diameter adapted to rest on and fit various-sized cooking utensils having top edges of about 8 inches to about 14 inches in diameter. The inner diameter of the rigid base member 4 also preferably greater than the diameter of the substantially rigid rim 10, so that the collapsible guard member 6 in its fully expanded configuration extends upwardly and inwardly from the inner diameter of the rigid base member 4 on an angle from the rigid base member rigid base member 4 to the substantially rigid rim 10, forming a collapsible guard member 6 having truncated conical shape.

The central opening 12 defined by the substantially rigid rim 10 of the collapsible splatter guard 2 is preferably large enough to permit the user to observe the food items being prepared within the cooking utensil as well as stir and/or turn the food items without removing the splatter guard 2 from the edge of the cooking utensil.

The collapsible guard member 6 in its fully expanded configuration acts as a retention wall, catching any splattering materials and preventing them from splattering onto the adjacent surfaces, as well as the user. The conical shape of the flexible wall 8 of the collapsible guard member 6 further facilitates the downward drain of the splattering materials back into the cooking utensil.

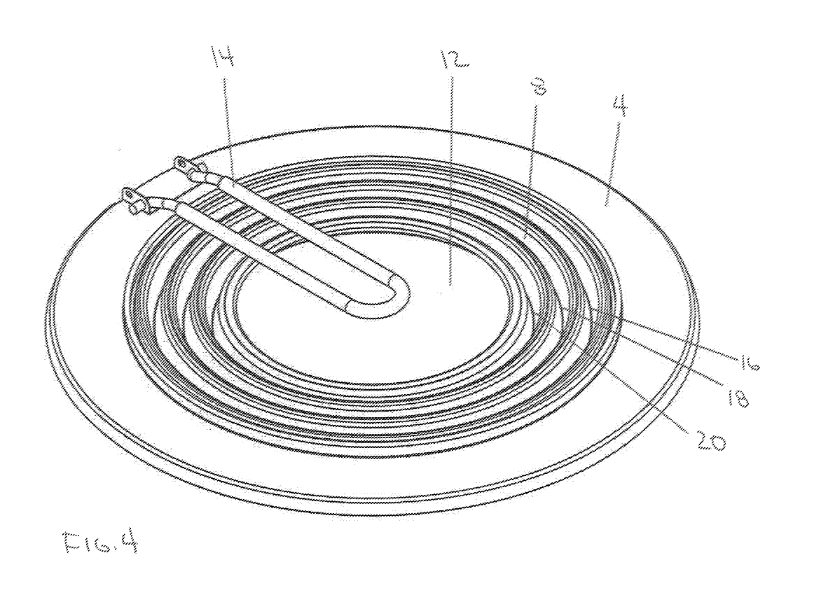

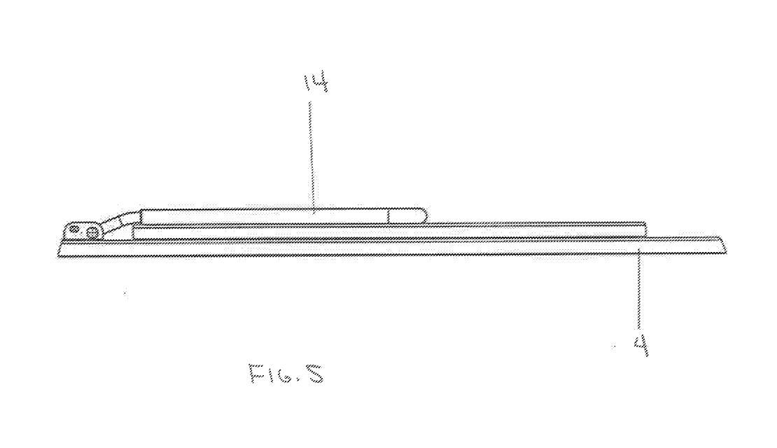

Although collapsing the collapsible guard member 6 can be facilitated by any number of folds or living hinges within the flexible wall 8, a first fold 16 adjacent the base flange 4 and two intermediate folds 18, 20 within the flexible wall 8 of the collapsible guard member 6 provides a preferred embodiment. As shown in FIGS. 4 and 5, the preferred collapsible guard member 6 in its collapsed configuration has a height only slightly higher than the height of the rigid base member 4.

The flexible wall 8 of the collapsible guard member 6 is preferably made of an elastomeric material, such as a temperature resistant thermoplastic material, for ease of collapsing the guard member 4 along the fold lines 12, 14, 16. In a preferred embodiment, the substantially rigid rim 10 is composed of any suitable substantially rigid and durable material such as aluminum, rubber, or plastic, but preferably stainless steel. Of course, other suitable materials may also be used to arrive at the present invention. For example, the collapsible guard member 6 may alternatively be formed from one or more silicone materials and the substantially rigid rim 10 may be formed from one or more metal, or other rigid or semi-rigid materials.

Each of the one or more folds of the collapsible guard member 6 is most preferably formed as a living hinge in which the elastomeric material forming the flexible wall 8 is somewhat thinner along the fold lines 16, 18, 20 than the surrounding material, thereby making the material at the living hinge more susceptible to folding than the surrounding material. While the living hinge is formed by use of a thinner section of material in the preferred embodiment, it should be understood that the folding sections can be produced in other means in order to manufacture a location that is more likely to bend or fold than other areas.

In the preferred collapsible splatter guard 2 shown, the rigid base member 4 is constructed to rest on the top edge of a cooking utensil. The rigid base member 4 may be composed of any substantially rigid and durable material suitable to securely support For example, stainless steel, aluminum, or plastic, preferably aluminum.

The collapsible splatter guard 2 further preferably comprises a handle 14, allowing the user to easily place and remove the splatter guard 2 from the top edge of the cooking utensil. It is further preferred that the handle 14 is pivotally attached to the base flange 4, allowing the user to fold the handle over the top of the collapsible guard member 6 when the collapsible guard member 6 is in its fully collapsed configuration. The handle 14 most preferably comprises a coating of an elastomeric material, such as a high temperature elastomeric coating, to provide a non-slip, heat resistant characteristic for better handling by the user. Although any non-slip, heat resistant material can be used, use of the thermoplastic elastomeric material that is used for the flexible middle section of the collapsible guard member 6 is preferred.

Variations, modifications and alterations to the above detailed description will be apparent to those skilled in the art. All such variations, modifications and/or alternatives are intended to fall within the scope of the present invention, limited only by any allowed claims. All cited patents and publications are hereby incorporated by reference.

Any and all patents and/or patent applications referred to herein are hereby incorporated by reference.

1. A collapsible splatter guard comprising a rigid base member having an inner perimeter and an outer perimeter and a collapsible guard member, the collapsible guard member being convertible from a fully collapsed configuration to a fully expanded configuration and having an opening.

2. The collapsible splatter guard of claim 1 wherein the collapsible guard member extends upwardly and inwardly from the inner perimeter of the rigid base member to a terminal edge.

3. The collapsible splatter guard of claim 1 wherein the collapsible guard member further comprises a rigid rim about a terminal edge of the flexible wall.

4. The collapsible splatter guard of claim 1 wherein the flexible wall comprises one or more folds for collapsing the guard member.

5. The collapsible splatter guard of claim 1 wherein the flexible wall is coupled to the inner perimeter of the rigid base member.

6. The collapsible splatter guard of claim 6 wherein the flexible wall comprises a high temperature elastomeric material.

7. The collapsible splatter guard of claim 1 wherein the inner perimeter of the rigid base member has a diameter that is greater than a diameter of the opening of the collapsible guard member.

8. The collapsible splatter guard of claim 1 wherein the inner perimeter of the rigid base member is circular, having a diameter of from about 7 inches to about 10 inches.

9. The collapsible splatter guard of claim 1 wherein the outer perimeter of the rigid base member is circular, having a diameter of from about 10 inches to about 15 inches.

10. The collapsible splatter guard of claim 1 further comprising a handle.

11. The collapsible splatter guard of claim 10 wherein the handle is pivotally attached to the rigid base member of the collapsible splatter guard.

12. The collapsible splatter guard of claim 10 wherein the handle comprises a high temperature elastomeric material.
